(19) United States
(12) Patent Application Publication
(10) Pub. No.: US 2012/0109563 A1
(43) Pub. Date: May 3, 2012

(54) METHOD AND APPARATUS FOR QUANTIFYING A BEST MATCH BETWEEN SERIES OF TIME UNCERTAIN MEASUREMENTS

(75) Inventors: Kwang-Chung Eddie HAAM, Burnaby (CA); Peter HUYBERS, Cambridge, MA (US)

(73) Assignee: PRESIDENT AND FELLOWS OF HARVARD COLLEGE, Cambridge, MA (US)

(21) Appl. No.: 13/284,171

(22) Filed: Oct. 28, 2011

Related U.S. Application Data
(60) Provisional application No. 61/408,096, filed on Oct. 29, 2010.

(51) Int. Cl. G06F 17/18; G01D 18/00

(52) U.S. Cl. 702/89; 702/181

(57) ABSTRACT

The best match of two time-uncertain series is quantified with a degree of confidence by selecting one of the time series and repeatedly computing a maximum covariance between the selected time series and a series of random records with the same distribution and expected autocorrelation as the non-selected time series. The resulting distribution of maximum covariances can be used to determine a degree of confidence by determining the percentage of those computed maxima which lie below the maximum covariance associated with the best match.

### BACKGROUND

In many applications values of physical phenomenon are measured and recorded at discrete time intervals. It is often desirable to determine whether two such time series of values represent the same, or similar, phenomena. For example, in speech recognition, a time series of values representing a spoken word can be compared against pre-recorded time series representing different spoken words in order to determine which word was uttered by the speaker.

This comparison is often performed by using statistical measures with the two series. For example, a value called the “covariance” of the two series can be calculated and the magnitude of the covariance used to determine whether the series are similar or not. However, it is well-known that statistical measures of relationships between two time series of values are generally altered by the presence of uncertainty in timing between the two series (called “time-uncertain series”). For example, the magnitude of the covariance calculated between two time series which actually represent the same phenomena will generally be decreased by uncertainty in timing between the two series. Using statistical measures alone it may be difficult to determine whether time series representing two spoken words in fact represent the same spoken word if one speaker is speaking faster than another.

Consequently, much previous work on this subject has sought to maximize some goodness of fit between two time-uncertain series either heuristically or through more quantitative methods. For example, various algorithms have been proposed to maximize the cross correlation, to maximize covariance, or to minimize the sum of the residual of squared difference between records within certain constraints while others have sought to maximize coherence, variance explained by empirical orthogonal functions and the relationship between empirical mode decompositions of time-uncertain records. Other approaches have employed visual “wiggle matching” between time-uncertain series.

One method called “dynamic time warping” is a well-known algorithm for measuring similarity between two time series which may vary in time or speed. Using this algorithm similarities in patterns between physical phenomena would be detected, even if in one series a phenomenon was occurring slowly and if in another the phenomenon was occurring more quickly, or even if there were accelerations and decelerations in the occurrence of the phenomenon during the course of one observation, or errors in measuring the timing of events. In accordance with the dynamic time warping algorithm, one or both of the time series are modified or “warped” non-linearly in the time dimension in order to align sequences of the values so that a measure of their similarity can be determined independent of certain non-linear variations in the time dimension.

A problem with dynamic time warping and similar algorithms is that they only determine the “best” match between two time series, but do not indicate the “goodness” of the fit. The determined “best” match may, in fact, be a poor match and there is even a danger that unrelated records can be made to appear to represent similar phenomena by time adjustment.

### SUMMARY

In accordance with the principles of the invention, the best match is quantified with a degree of confidence by selecting one of the time series and repeatedly computing a maximum covariance between the selected time series and a series of random records, which are generated with the same statistical characteristics (expected autocorrelation and distribution) as the non-selected time series. The resulting distribution of maximum covariances can be used to determine a degree of confidence by determining the percentage of those computed maxima which lie below the maximum covariance associated with the best match.

In one embodiment, if both time series are time-uncertain, all timing uncertainties between the selected time series and the other time series are transferred to the selected time series. The non-selected time series becomes time certain and the selected time series remains time-uncertain with additional time uncertainty.

In another embodiment, the collection of generated random records has the same distribution and expected autocorrelation as the non-selected time series.

In still another embodiment, if the distribution of the non-selected time series is known, each random record is independently generated by generating a random realization with the same distribution as the distribution of the non-selected time series. These independent random numbers are then multiplied by Cholesky's decomposition of the autocorrelation matrix of non-selected time series in order to generate random time series which has the same expected autocorrelation as the non-selected time series.

In yet another embodiment, if the distribution of the non-selected time series is not known, each random record is generated by inverse transform sampling. As with the previous embodiment, these independent random numbers are then multiplied by Cholesky's decomposition of the autocorrelation matrix of non-selected time series in order to generate random time series which has the same expected autocorrelation as the non-selected time series.

In another embodiment, maximum covariances between the selected time series and the series of random records, which have the equivalent statistical characteristic (e.g. autocorrelation and distribution), are computed using a variant of a dynamic time warping algorithm.

### BRIEF DESCRIPTION OF THE DRAWINGS

FIGS. 1A and 1B, when placed together, form a flowchart showing the steps in an illustrative method for quantifying a best match between two time series.

FIG. 2 is a flowchart illustrating the steps in a process for generating a series of autocorrelated random numbers.

FIG. 3 shows exemplary graphs of observations versus time where one time series is, or has been converted to, a time-certain series whereas the other series is a time-uncertain series where the time uncertainty is schematically represented by the dotted lines.

FIG. 4 shows exemplary graphs of a plurality of random number series that are to be used to compute maximum covariances with the time uncertain series shown in the graph 302 of FIG. 3.

FIG. 5 is a graph indicating schematically the computation of the maximum covariance between the time certain series in graph 300 and time uncertain series shown in the graph 302 in FIG. 3.

FIG. 6 is a graph of an exemplary time-certain series used in the generation of random number series, which has the same autocorrelation.

FIG. 7 is a graph plotting the autocorrelation values of the time series shown in FIG. 6 against autocorrelation lags varying from 0 to 449.

FIG. 8 is a plot of the random number series generated from the time series shown in FIG. 6 which have the same distribution and autocorrelation as the time series shown in FIG. 6.

### DETAILED DESCRIPTION

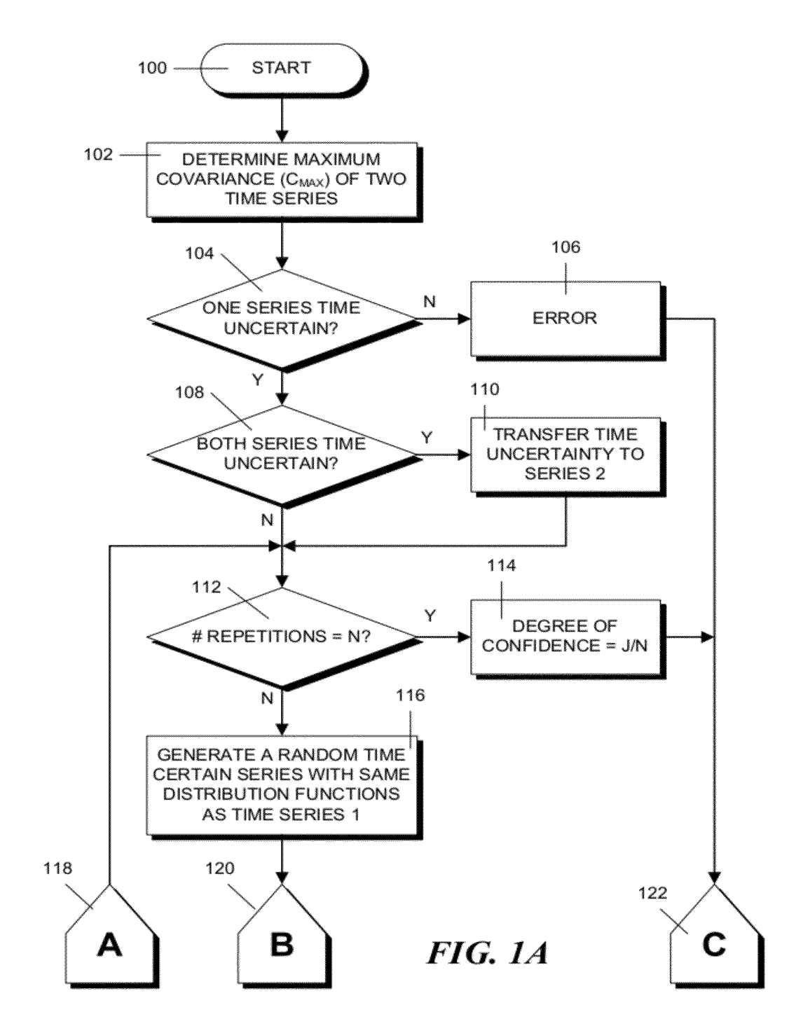

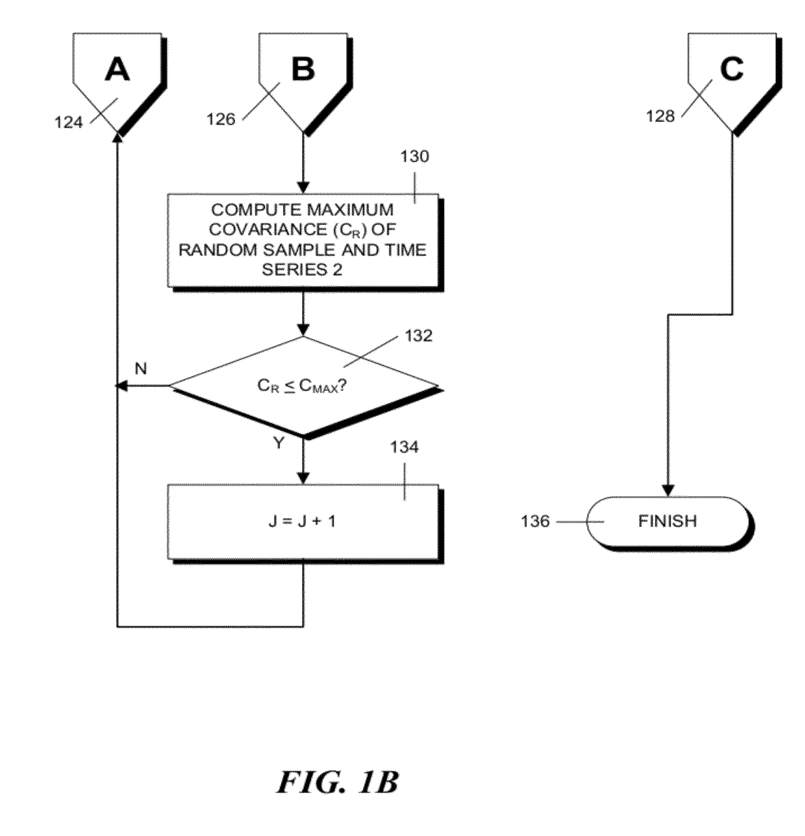

The steps in the inventive method are shown in FIGS. 1A and 1B which form a flowchart when placed together. This method starts in step 100 and proceeds to step 102 where a best match between two time series is obtained. As previously mentioned these two time series might represent speech recognition signals, electrocardiogram signals, gene expression data or other time series data. The best match can be determined via the dynamic time warping algorithm discussed above or variants of this algorithm or other known pattern recognition algorithms. Once the best match has been obtained, the inventive method will quantify the match or determine the “goodness of fit” as a degree of confidence.

Specifically, the process proceeds to step 104 where a determination is made whether at least one of the time series is time-uncertain. The inventive method is not applicable if neither time series is time-uncertain. Therefore, if both time series are time-certain, the process proceeds to step 106 where and error is generated. The process then proceeds, via off-page connectors 122 and 128 to end in step 136.

Alternatively, if in step 104 it is determined that at least one time series is time-uncertain, then the process proceeds to step 108 where a determination is made whether both time series are time-uncertain. The expected covariance between two time-uncertain series is only a function of the relative timing errors between the series and does not depend on which series that timing error belongs (to at least up to issues involved with re-sampling of the series). Specifically, for two time series y(t+e_{y}) and x(t+eₓ) where the terms e_{y} and eₓ represent timing error terms, the covariance cov(y(t+e_{y}), x(t+eₓ)) equals the covariance cov(y(t+e_{y}−eₓ), x(t)). Therefore, in order to reduce the complexity of the processing, all of the relative time uncertainty between the series is assigned to one of the series, which is hereinafter denoted as time series 2. In particular, if a determination is made in step 108 that both time series are time-uncertain, then the process proceeds to step 110 where the time uncertainty of one series is transferred to the other series. The result is one time certain series (time series 1) and one time-uncertain series (time series 2.)

In some cases transfer of the timing errors to one of the time series may change the distribution of the maximum covariance. In these cases, step 102 can be performed after the timing error transfer (immediately prior to step 112) in order to insure that the correct confidence level is computed.

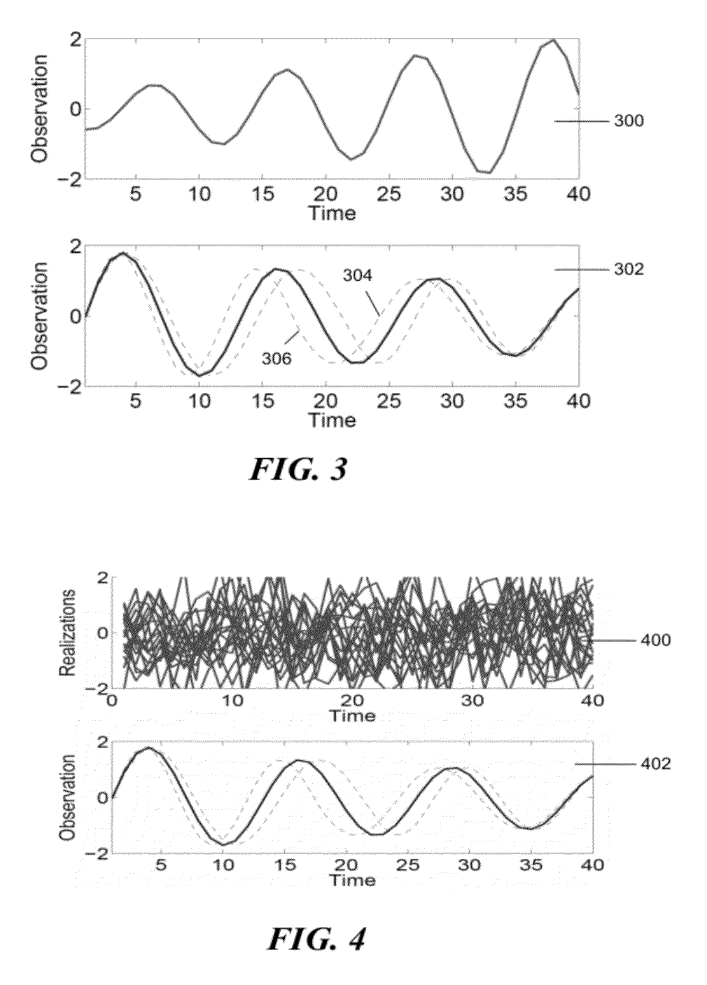

Example graphs of two such time series are shown in FIG. 3. Time series 300 represents the time-certain time series (time series 1) and time series 302 represents the time-uncertain time series (time series 2). The dotted lines 304 and 306 show the extent of the time uncertainty.

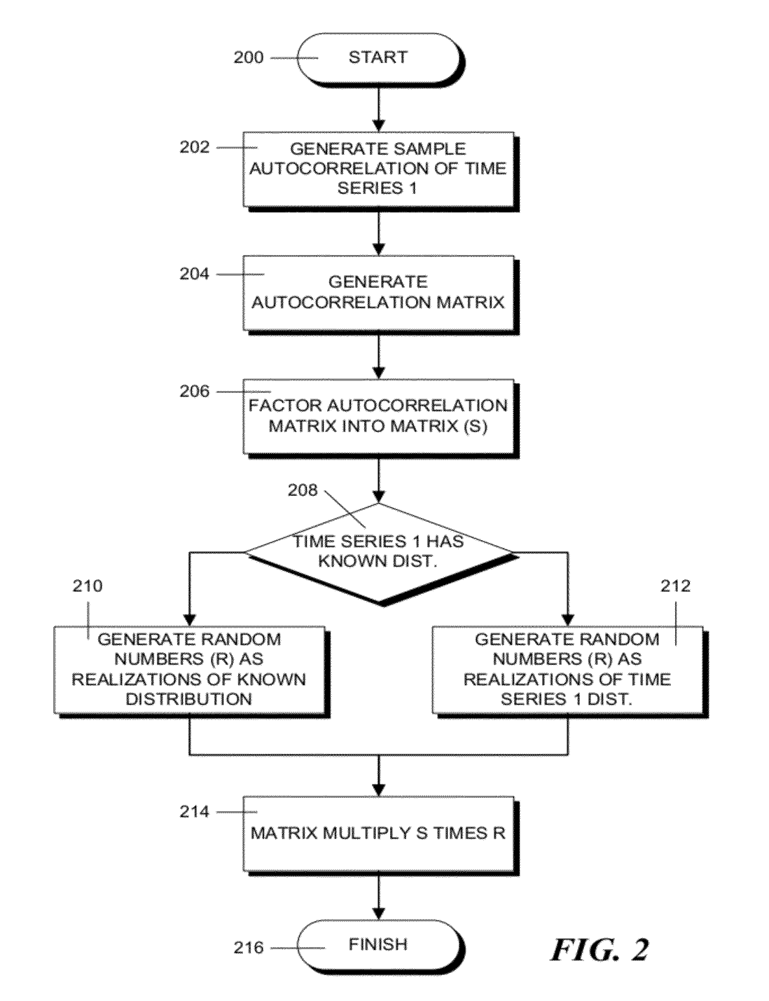

Some of the steps (116, 130, 132 and 134) in the process must be repeated many times in order to get an accurate result. The higher the number of repetitions, the more accurate the result. The number of repetitions (denoted as N) may be low (200) for a rough estimate or high (≧10,000) for an accurate estimate. In step 112, a determination is made whether the number of repetitions equals N. If not, the process proceeds to step 116 where a randomly-realized time series having an identical autocorrelation function and distribution function is generated. In theory, step 116 is equivalent to generating random series of an autoregressive model with order M, where M is the length of the series and the coefficients are the same as sample autocorrelation of the series. The generation process is shown in FIG. 2.

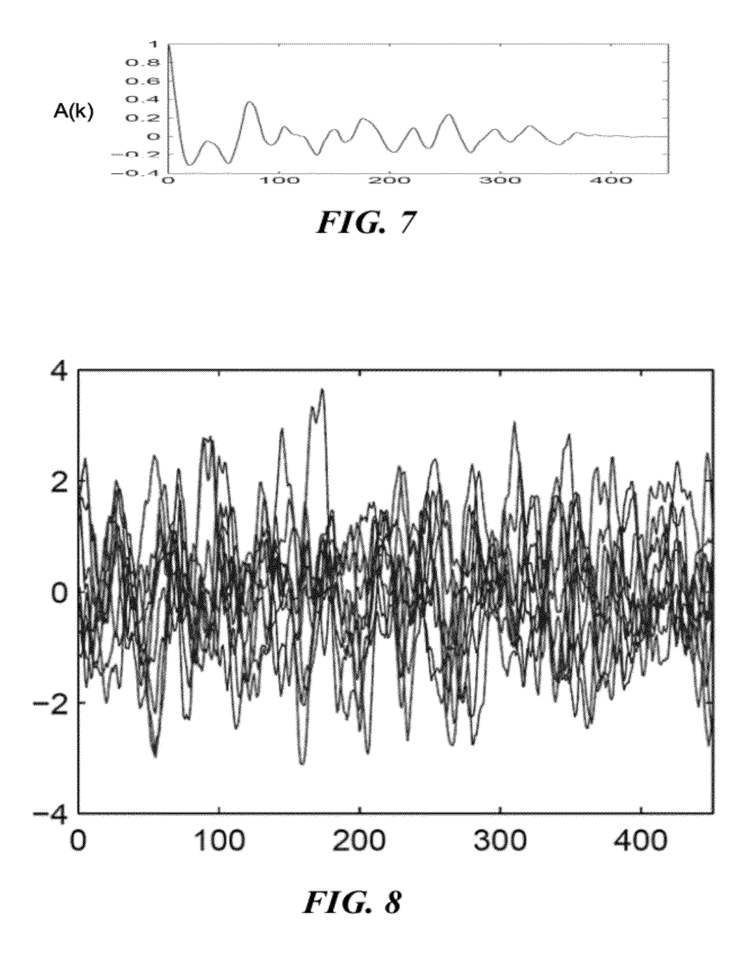

As shown in FIG. 2, the generation process starts in step 200 and proceeds to step 202 where values of the sample autocorrelation function of time series 1 (with length M) are generated using autocorrelation lags zero through M−1. The autocorrelation value can be generated by any well-known algorithm. As an example, for the time series shown in FIG. 6, the autocorrelation values A(k) are computed for the time series where k is the lag. When the A(k) values are plotted against k the result is shown in FIG. 7.

Next, in step 204, an autocorrelation matrix (G) is generated. G is an M by M matrix of the form:

$$[ \begin{matrix}A ( 0 ) & A ( 1 ) & A ( 2 ) & A ( 3 ) & A ( 4 ) & … & … & A ( M - 1 ) \\ A ( 1 ) & A ( 0 ) & A ( 1 ) & A ( 2 ) & A ( 3 ) & … & … & A ( M - 2 ) \\ A ( 2 ) & A ( 1 ) & A ( 0 ) & A ( 1 ) & A ( 2 ) & … & … & … \\ A ( 3 ) & A ( 2 ) & A ( 1 ) & A ( 0 ) & A ( 1 ) & A ( 2 ) & … & … \\ … & … & A ( 2 ) & A ( 1 ) & A ( 0 ) & A ( 1 ) & … & … \\ … & … & … & A ( 2 ) & A ( 1 ) & … & … & A ( 2 ) \\ … & … & … & … & … & … & … & A ( 1 ) \\ A ( M - 1 ) & … & … & A ( 4 ) & A ( 3 ) & A ( 2 ) & A ( 1 ) & A ( 0 )\end{matrix} ]$$

Where A(k) are the autocorrelation values, the diagonals are equal to A(0), the first sub-diagonals are A(1), the second sub-diagonals are A(2) etc.

In step 206 the Cholesky Decomposition (S) of the autocorrelation matrix G is computed. The Cholesky Decomposition is a well-known method for reducing certain matrices. In order to evaluate the Cholesky Decomposition, the covariance matrix must be positive definite. Since many of the possible time series realizations will be highly correlated and the autocorrelation structure is arbitrary, the covariance matrix may not necessarily be positive definite. In cases where the matrix is not positive definite, a spectral decomposition can be used to find a positive definite approximation to the covariance matrix by eliminating non-positive eigenvalues, for example as set forth in Anderson, E., et al. (Eds.) (1999), LAPACK User's Guide, 3rd edition, Society for Industrial and Applied Mathematics, Philadelphia, Pa. If the magnitude and proportion of the non-positive eigenvalues are small, the spectral decomposition approximation is sufficiently accurate.

Next, it is necessary to generate a series of univariate independent random numbers (the series is denoted as R and has a length of M) which has the same distribution as the time series 1. In step 208, a determination is made whether the distribution of time series 1 is a known distribution, such as a normal distribution, (a Chi-square or exponential distribution, etc.) with N(μ, σ), then the process proceeds to step 210 where each elements in the series of random numbers R=[r₁, r₂, r₃, r₄, . . . , r_{M}] is assigned a random realization of N(μ, σ).

Alternatively if time series 1 is an unknown arbitrary distribution, then the process proceeds to step 212 where the time series R is generated by a conventional inverse transform sampling method. This method is described in a Wikipedia article entitled “Inverse transform sampling” and generally, for example, proceeds in accordance with the following steps:

First, generate the cumulative distribution of time series 1. The cumulative distribution has a length of M and is formed by the program:

```
aaa = sort(x)
for i = 1 to length(aaa)
    xx(i) = aaa(i)
    yy(i) = i / length(aaa)
end
```

where x is the time series 1. plot(xx,yy) produces cumulative distribution of time series 1.

Next, for each element of R (R(i)), generate a uniformly distributed random number (u) between 1 and M and set the value of the element R(i)=xx(u). The resulting R is a vector (with a size of M) where each element is a random number with the same distribution as time series 1.

Finally, in step 214, multiply R by S (using matrix multiplication) so that the resulting vector (with length M) is a random time series, which has the same distribution and autocorrelation as time series 1. The process then finishes in step 216. Note that in order to generate additional univariate independent random numbers, it is only necessary to repeat either steps 210 or 212 (depending on whether time series 1 is normally distributed) and step 214. The results of this processing are a plurality of random sequences, such as those shown in FIG. 8, where each trace represents a random time sequence for the time series shown in FIG. 6.

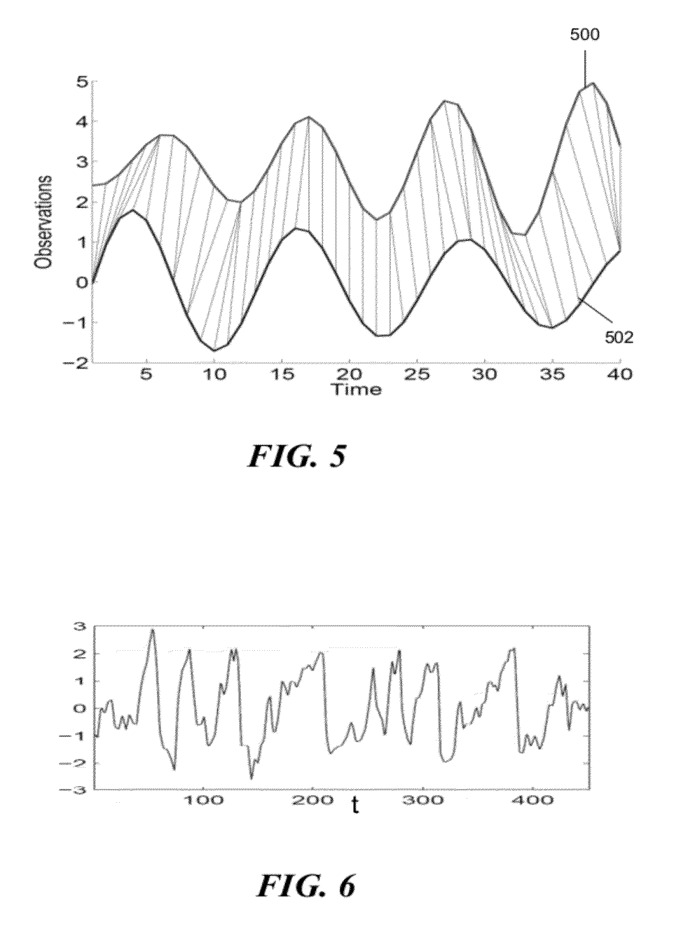

Returning to FIGS. 1A and 1B, after the autocorrelated random time series is generated in step 116, the process proceeds, via off-page connectors 120 and 126, to step 130 where the maximum covariance (C_{R}) between the autocorrelated random time series generated in step 116 and time series 2 is computed. This computation can be performed in a variety of manners, for example by using the aforementioned dynamic time warping algorithm, variants of this algorithm or other known pattern recognition algorithms. FIG. 4 shows an example of the plurality of autocorrelated random time sequences 400 and the time-uncertain time sequence 2 (402). FIG. 5 graphically illustrates computing the maximum similarity of time certain series 500 and time series 2 502 via basic dynamic time warping.

Using the basic time warping algorithm for two time-uncertain series A and B:

A=a₁,a₂,a₃,a₄,a₅, . . . ,aₘ

B=b₁,b₂,b₃,b₄,b₅, . . . ,bₘ,

the maximum similarity between the series can be found by shifting times. In this example, the first and the last data points are assumed to be time-certain for simplification. The first step of dynamic time warping algorithm is to find the time alignment that generates the maximum similarity by creating an m by m matrix of all possible matches of the two serial data. Each element of the matrix is a measure of similarity that is numerically computed as the difference squared:

d(aᵢ,bⱼ)=(aᵢ−bⱼ)²

The warping path is a continuous set of elements of the matrix with minimum sum of difference squared. It can be found efficiently by constructing a cumulative difference matrix, where each element is determined by the following recurrence relations:

D(i,j)=d(aᵢ,bⱼ)+min[D(i−1,j−1),D(i−1,j),D(i,j−1)]

where D(i, j) is the minimum cumulative difference, which is the sum of difference d(i, j) found in the current cell and the minimum of the cumulative difference of the adjacent elements. The warping path with minimum sum of difference squared can be found by choosing adjacent elements with minimum cumulative distance.

When the warping path moves vertically (or horizontally) by one step, two data points of the series are simultaneously aligned with one data point of the other series. The transition from (i, j) to (i−1, j−1) is possible in two different ways, one diagonal step, or combination of one horizontal and one vertical step. Because the diagonal path requires half the sum of difference than combined horizontal and vertical path, the warping path is biased to choose the diagonal path. It is possible to weight the paths so that all paths are chosen equally.

The basic DTW algorithm may not necessarily result in an alignment with the maximum covariances. In an article entitled “Correlation Optimized Warping and Dynamic Time Warping as Preprocessing Methods for Chromatographic Data”, Tomasi, G., F. van den Berg, and C. Andersson (2004), J. Chemometrics, 18, 231-241 a modified dynamic time warping algorithm with some restrictions was found find the maximum co-variances. First, the modified algorithm restricted the number of consecutive vertical or horizontal paths so that excessive compression or expansion of the data is avoided, and the shape of the original data is preserved as much as possible. Second, the modified algorithm employed a synchronization scheme. For example, when one vertical path is followed by two diagonal paths, three distinct points are aligned against two data points of the other series. In order to align same number of data points, two data points are interpolated into three points.

In addition, some time or other restraints may be introduced into the data. For example, in some situation, certain data points are not realistically possible and these can be eliminated.

Returning to FIG. 1, in step 132, the maximum covariance C_{R} is compared to the maximum covariance (C_{MAX}) for which a degree of confidence is to be calculated. If C_{R} is less than or equal to C_{MAX} then, in step 134 a counter variable (J) is incremented (J is initialized to zero). If C_{R} is greater than C_{MAX} then the counter variable J is not incremented. In either case the process returns, via off-page connectors 124 and 118, to step 112 where again the number of repetitions is compared to N.

Operation continues in this manner with steps 112, 116, 130, 132 and 143 being repeated until the number of repetitions equals N. At this point the process proceeds to step 114 where the degree of confidence is calculated as J divided by N. The process then proceeds, via off-page connectors 122 and 128 to finish in step 136.

Although one embodiment of the invention has been described in detail, those skilled in the art will understand that other application of the inventive concept are apparent. For example, although the inventive method has been shown to quantify the best match of two time series, the inventive method can also be used to quantify the best coherence match of two series in the frequency domain using a process known as “Dynamic Frequency Warping”. Dynamic Frequency Warping is explained in more detail in an article entitled “Speaker Normalization using Dynamic Frequency Warping”, Z. Huang, L. Hou, International Conference on Audio, Language and Image Processing, Shanghai, China (Jul. 7-9, 2008), pp. 1091-1095.

Although only a few time series have been discussed, those skilled in the art would understand that the principles of the invention are directly applicable to other similar time series, such as MRI time series, electroencephalogram signals, gene expression time series (including fungus), music melody signals (used for recognition or search), sound signals of killer whales (used for recognition), radar signals, sonar signals, bird song signals, neural signals, chromatography time series, brain cortex response signals, protein production data, paleogeomagnetic data and electromyographic (EMG) signals. Similar time series are also found in the areas of robotics, image recognition, evolutionary biology, gene clustering, climate, meteorology, paleoclimatology, seismology, oceanography, atmospheric sciences, planetary sciences, chemical processes, astronomy, archaeology, archaeobiology and neurophysiology. The inventive principles are directed applicable to these also.

Further, the invention is also applicable to measures of similarity between time-uncertain series other than covariance. These other measures include correlation coefficients, variants of correlation coefficients (e.g. ranked correlation coefficients), coherence, variants of coherence (e.g. causal coherence), co-integration and its variants, causality and its variants, cross-spectrum and its variants, transfer functions and its variants.

While the invention has been shown and described with reference to a number of embodiments thereof, it will be recognized by those skilled in the art that various changes in form and detail may be made herein without departing from the spirit and scope of the invention as defined by the appended claims.

What is claimed is:

1. A method for quantifying with a degree of confidence a best match between two series of observations of physical phenomena taken at time uncertain intervals over a period of time, comprising:
(a) selecting one of the time-uncertain series;
(b) generating a series of random records having a same distribution and expected autocorrelation as the non-selected time series;
(c) repeatedly computing a maximum covariance between the selected time-uncertain series and each of the random records;
(d) determining the degree of confidence equal to a percentage of those computed maximum covariances which are less than a maximum covariance associated with the best match.

2. The method of claim 1 wherein, when both time series are time-uncertain, step (a) comprises transferring all relative timing errors between the selected time series and the non-selected time series to the selected time series so that the non-selected time series becomes time-certain and the selected time series remains time-uncertain.

3. The method of claim 2 wherein step (b) comprises generating a sample autocorrelation of the non-selected time series and forming an autocorrelation matrix.

4. The method of claim 3 wherein step (b) comprises factoring the autocorrelation matrix into factors.

5. The method of claim 4 wherein step (b) comprises factoring the autocorrelation matrix with a Cholesky decomposition.

6. The method of claim 5 wherein step (b) comprises, when a distribution of the non-selected time series is known, generating an independent random realization with a distribution that is the same as the distribution of the non-selected time series and when a distribution of the non-selected time series is not known, generating an independent random realization by inverse transform sampling.

7. The method of claim 6 wherein step (b) further comprises generating the autocorrelated random records by multiplying the autocorrelation factors resulting from Cholesky's decomposition by the independent random realizations.

8. The method of claim 1 wherein step (c) comprises repeatedly computing maximum covariances between the selected time series and each of the series of autocorrelated random records using a variant of a dynamic time warping algorithm.

9. The method of claim 1 wherein the time series represent one of the group consisting of speech recognition signals, airline flight schedules, electrocardiogram signals and gene expression data.

10. A method for quantifying with a degree of confidence a best match between two signals consisting of a plurality of frequencies, comprising:
(a) selecting one of the frequency series;
(b) generating a series of random records, each having a same distribution and expected autocorrelation as the non-selected frequency series;
(c) repeatedly computing a maximum coherence between the selected frequency series and each of the random records;
(d) determining the degree of confidence equal to a percentage of those computed maximum coherences which are less than a maximum coherence associated with the best match.
